(19) United States
(12) Patent Application Publication
(10) Pub. No.: US 2003/0068175 A1
(43) Pub. Date: Apr. 10, 2003

(54) Image forming apparatus

(76) Inventors: Kenji Asuwa, Toride (JP); Kazutaka Sato, Kashiwa (JP); Masahiro Yagi, Chiyoda (JP); Isao Nakajima, Hitachinaka (JP); Yukio Otome, Tokai (JP); Akihiko Yamazaki, Hitachinaka (JP)

Correspondence Address: ANTONELLI TERRY STOUT AND KRAUS, SUITE 1800, 1300 NORTH SEVENTEENTH STREET, ARLINGTON, VA, 22209

(21) Appl. No.: 10/216,725

(22) Filed: Aug. 13, 2002

(30) Foreign Application Priority Data
Oct. 4, 2001 (JP) 2001-308147

(51) Int. Cl. G03G 15/00

(52) U.S. Cl. 399/162

(57) ABSTRACT

An image forming apparatus comprising an endless belt as an image carrier characterized by reduced image misregistration and reduced machining cost. When the above stated endless belt feed path is divided into a path from a drive roller to a tension roller, and a path from the tension roller to the drive roller, the eccentricity of the idle roller located on the path on the side including a latent image forming point is set to a value smaller than that of the idle roller located on the path not including the image forming point.

### BACKGROUND OF THE INVENTION

1. Field of the Invention

The present invention relates to an image forming apparatus.

2. Prior Art

An image forming apparatus is a device where electric charge is applied to an image carrier such as a photoconductor, and a latent image is formed by removing this electric charge using an exposure apparatus such as laser or light emitting diode. Further, it is a device for obtaining a visible image by attaching a toner image to the position of this latent image by means of a development apparatus. The above stated so-called electrophotographic printing type image forming apparatus has come into common use in recent years.

This electrophotographic printing type image forming apparatus uses an endless belt driven in circulation as an image carrier. This endless belt has a higher degree of freedom with respect to the layout of the exposure apparatus, development apparatus and other apparatuses, and can be used to downsize the image forming apparatus.

The endless belt is applied to multiple rollers. It generally comprises a drive roller for giving drive force to the belt, a tension roller for adding tension to ensure stable belt feed and multiple idle rollers for defining a belt feed path.

The above stated rollers have a predetermined eccentricity in conformity to the machining accuracy thereof. The eccentricity causes fluctuation of the belt feed speed and misregistration in image formation, hence, image distortion, resulting in a considerable deterioration of image quality.

Furthermore, in a color image forming apparatus for forming a multicolor image through overlay of multiple monochromatic toner images, a misregistration in color overlay is caused by roller eccentricity, resulting in a considerable deterioration of image quality.

The above stated problems are not limited to the image carrier. The same problems are found in an intermediate transfer member in a so-called intermediate transfer member type image forming apparatus wherein an image is formed on a recording medium after the toner image formed on the image carrier is transferred on the belt-shaped intermediate transfer member.

The misregistration of image caused by roller eccentricity can be reduced by keeping the eccentricity within a predetermined range through high precision machining of a roller. However, improved machining accuracy involves higher machining cost. For this reason, application of this principle has been limited.

To solve this problem, various proposals have been made to disclose techniques for meeting the required image level without depending on high roller machining accuracy.

For example, Japanese Application Patent Laid-Open Publication No. Hei 08-137153 discloses a method wherein the value obtained by subtracting a predetermined value from the distance between the exposure point and transfer point is defined as an integral multiple of the peripheral length of a drive roller, whereby the influence of image misregistration on the belt shaped image carrier resulting from roller eccentricity is cancelled on the transfer member.

### SUMMARY OF THE INVENTION

However, the above stated prior art has been intended to solve the problem of deterioration in image quality caused by the eccentricity of a drive roller. No action is taken for the eccentricity of idle rollers commonly provided in multiple numbers. Accordingly, when the above stated prior art is adopted, it is necessary to machine all idle rollers to such an accuracy as to ensure that a predetermined level of eccentricity is not exceeded. This is the cause for higher production costs.

The object of the present invention is to provide an image forming apparatus free from image misregistration.

The above object can be achieved by an image forming apparatus comprising; a latent image forming apparatus further comprising a belt shaped carrier applied on a drive roller, multiple idlers and a tension roller, the above stated latent image forming apparatus mounted on the above stated belt shaped carrier, a developing apparatus for applying toner on the latent image formed by the above stated latent image forming apparatus, and a transfer apparatus for transferring the toner image formed by the above stated developing apparatus; the above stated image forming apparatus further characterized in that, when a path leading from the above stated drive roller to the above stated tension roller in the forward direction of the above stated belt shaped carrier is defined as a drive roller downstream path, and a path leading from the above stated tension roller to the above stated drive roller is defined as a drive roller upstream path; the amount of eccentricity of the idle roller located on the above stated drive roller downstream path is made smaller than that of the idle roller located on the above stated drive roller upstream path, and the above stated latent image forming apparatus is arranged on the above stated drive roller downstream path.

The above object can also be achieved by an image forming apparatus characterized in that; when a path leading from the above stated drive roller to the above stated tension roller in the forward direction of the above stated belt shaped carrier is defined as a drive roller downstream path, and a path leading from the above stated tension roller to the above stated drive roller is defined as a drive roller upstream path; the amount of eccentricity of the idle roller located on the above stated drive roller upstream path is made smaller than that of the idle roller located on the above stated drive roller downstream path, and the above stated latent image forming apparatus is arranged on the above stated drive roller upstream path.

The above object can also be achieved by an image forming apparatus characterized in that, when the radius of the above stated idle roller is “r”, eccentricity “e”, winding angle θ[rad] and the maximum permissible misregistration “d”, the eccentricity “e” of the idle roller arranged on the path including the position of the above stated latent image forming apparatus is expressed as e<d(θ/π).

The above object can also be achieved by an image forming apparatus characterized in that the eccentricity of the idle roller having a greater winding angle of the above stated belt shaped carrier is smaller than that of the idle roller having a smaller winding angle.

The above object can also be achieved by an image forming apparatus comprising; multiple monochromatic image forming means further comprising a belt shaped intermediate transfer member applied on a drive roller, multiple idlers and a tension roller, the above stated monochromatic image forming means mounted on the above stated belt shaped intermediate transfer member, a transfer apparatus for transferring on the above stated belt shaped intermediate transfer member the monochromatic toner image formed by the above stated monochromatic image forming means, and a transfer apparatus for transferring on a recording medium the colored image obtained by overlaying the above stated monochromatic toner images; the above stated image forming apparatus further characterized in that, when a path leading from the above stated drive roller to the above stated tension roller in the forward direction of the above stated belt shaped carrier is defined as a drive roller downstream path, and a path leading from the above stated tension roller to the above stated drive roller is defined as a drive roller upstream path; the amount of eccentricity of the idle roller located on the above stated drive roller downstream path is made smaller than that of the idle roller located on the above stated drive roller upstream path, and the above stated latent image forming apparatus is arranged on the above stated drive roller downstream path.

The above object can also be achieved by an image forming apparatus characterized in that; when a path leading from the above stated drive roller to the above stated tension roller in the forward direction of the above stated belt shaped carrier is defined as a drive roller downstream path, and a path leading from the above stated tension roller to the above stated drive roller is defined as a drive roller upstream path; the amount of eccentricity of the idle roller located on the above stated drive roller upstream path is made smaller than that of the idle roller located on the above stated drive roller downstream path, and the above stated latent image forming apparatus is arranged on the above stated drive roller upstream path.

The above object can also be achieved by an image forming apparatus characterized in that, when the radius of the above stated idle roller is “r”, eccentricity “e”, winding angle θ[rad] and the maximum permissible misregistration “d”, the eccentricity “e” of the idle roller arranged on the path including the position of the transfer point is expressed as e<d(θ/π).

The above object can also be achieved by an image forming apparatus characterized in that the eccentricity of the idle roller having a greater winding angle of the above stated belt shaped intermediate transfer member is smaller than that of the idle roller having a smaller winding angle.

The above object can also be achieved by an image forming apparatus wherein the above stated image forming apparatus comprises a support member for supporting the above stated tension roller rotating shaft in linearly movable manner, and the above stated support member comprises an elastic member; the above stated image forming apparatus further characterized in that; when the peripheral length of the above stated belt shaped carrier or intermediate transfer member is “1”, width “w”, thickness “t”, Young's modulus “E”, the total of the eccentricities of all rollers to which the above stated belt shaped carrier or intermediate transfer member is applied “Σe”, the maximum permissible image position misregistration “d” and angles formed by the above stated tension roller traveling direction and the upstream and downstream path of the above stated belt shaped carrier or intermediate transfer member α and β; then the spring constant k of the above stated elastic member can be expressed as k<wtE(cos α+cos β)d/(1Σe).

### BRIEF DESCRIPTION OF THE DRAWINGS

FIG. 1 is a diagram representing a configuration of an image forming apparatus as the first embodiment of the present invention;

FIG. 2 is a diagram representing the mechanism for producing belt speed fluctuation based on eccentric idle rollers;

FIG. 3 is a diagram defining the belt path;

FIG. 4 is a diagram representing another configuration of an image forming apparatus as the first embodiment of the present invention;

FIG. 5 is a diagram representing the positional relationship between a tension roller and belt; and

FIG. 6 is a diagram representing a further configuration of an image forming apparatus as the second embodiment of the present invention.

### DETAILED DESCRIPTION OF THE INVENTION

The following describes the embodiments of the present invention with reference to drawings:

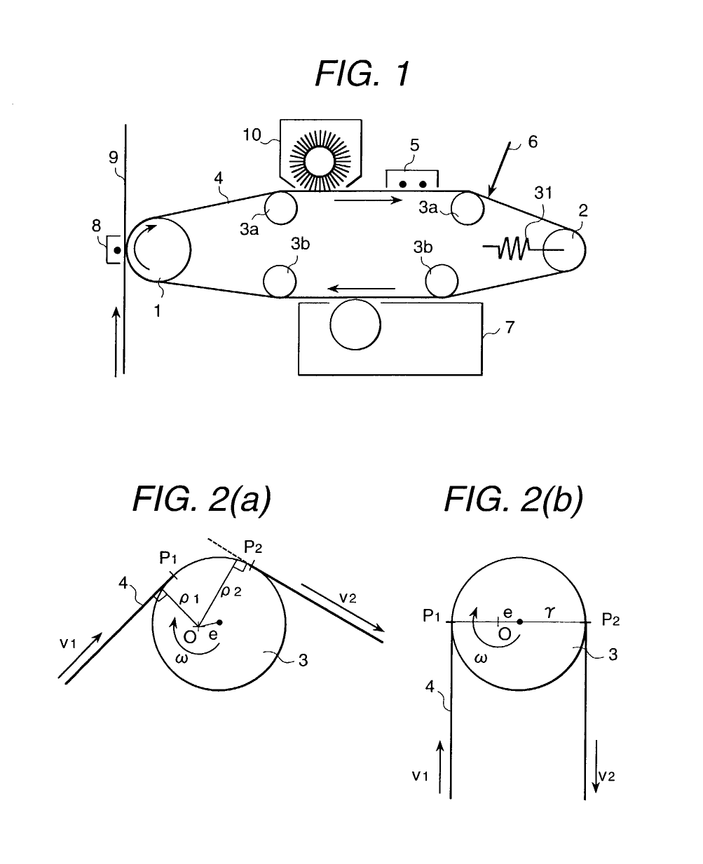

FIG. 1 is an image forming apparatus comprising the first embodiment of the present invention.

In FIG. 1, numeral 4 denotes an endless image carrier formed of a photosensitive belt, which is applied to a drive roller 1, a tension roller 2, tension roller shaft displacement means 31 for supporting the tension roller 2 in linearly movable manner, and idle rollers 3a and 3b.

An electric charging apparatus 5, a latent forming apparatus 6 comprising a laser and light emitting diode, a development apparatus 7, a transfer apparatus 8 and a cleaner 10 are arranged around the endless image carrier.

An image is formed by the image forming apparatus according to the following steps:

First, the image carrier 4 is electrically charged by the electric charging apparatus. In the figure, electric charge on the image carrier 4 rotating in the arrow-marked direction is removed by the latent image forming apparatus 6 at the image position conforming to the input data, whereby a latent image is formed. Then the development apparatus 7 applies toner to the site where the latent image has been formed, there by forming a toner image. After that, the toner image is transferred to the recording medium 9 such a recording paper by means of a transfer apparatus 8.

The toner image is fixed on the recording medium 9 by a fixing apparatus (not illustrated) in the final stage where image forming process terminates.

In the belt shaped image carrier applied to multiple rollers (hereinafter referred to as “belt” for simplicity) as described above, the eccentricity of idle rollers 3a and 3b causes fluctuation in belt speed.

FIG. 2(a) shows the fluctuation of the belt shaped image carrier speed in the areas before and after the position where a given idle roller 3 is eccentric.

In FIG. 2(a), the relationship among distance ρ₁ from rotation center O to the belt on the upstream side, instantaneous speed v₁ of the belt on the upstream side and instantaneous angular speed ω of the idle roller can be expressed as ω=v₁/ρ₁.

Meanwhile, the relationship among distance ρ₂ from rotation center O to the belt on the downstream side, instantaneous speed v₂ of the belt on the downstream side and ω can be expressed as ω=v₂/ρ₂.

Thus, the relationship between instantaneous speed v₁ of the belt on the upstream side and instantaneous speed v₂ of the belt on the downstream side can be expressed as v₂=(ρ₂/ρ₁)v₁.

This means that there is always a speed difference between the belts on the upstream and downstream sides when ρ₂ is not equal to ρ₁, namely, when the idle roller is eccentric.

ρ₁ and ρ₂ undergoes periodic fluctuation with the rotation of the idle roller, and this is the cause for fluctuation in speed.

FIG. 2(b) shows the case of winding angle θ=π[rad] where the belt speed difference is the greatest before and after the idle roller 3.

In FIG. 2(b), assume that the average belt speed is “v”, idle roller radius “r”, eccentricity “e” and average angular speed “ω”. Then we get ω=v/r.

Since ρ₁=r−e and ρ₂=r+e, the amplitude of the belt speed fluctuation is eω. The belt speed δvₘₐₓ in this case can be expressed approximately as follows:

δvₘₐₓ=eω sin ωτ

Here τ denotes time.

The speed fluctuation is proportional to the belt winding angle, so the speed fluctuation δv for the belt having a winding angle of θ is as follows:

δv=eω(θ/π)sin ωτ

Thus, the greater the belt winding angle, the greater the speed fluctuation before and after idle roller.

In this case, the color misregistration resulting from speed fluctuation can be obtained as follows:

∫{δv}dτ=eω(θ/π)(1/ω)cos ωt

The amplitude of e(θ/π) is obtained.

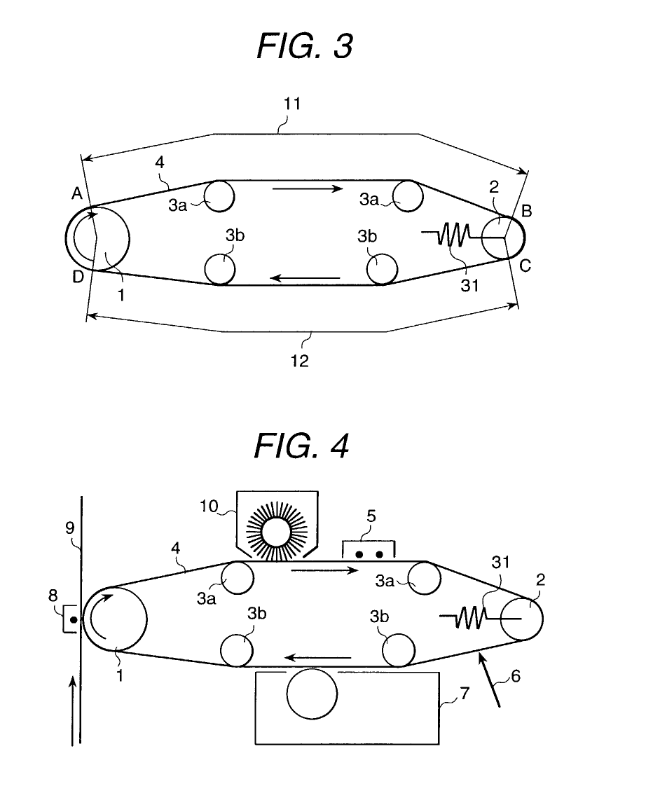

The following describes the propagation of the above stated speed fluctuation with reference to FIG. 3:

In FIG. 3, the belt speed fluctuation resulting from idle roller eccentricity is considered to come from the influence of the position fluctuation caused by eccentricity. When the belt does not extend or contract, the influence of the position fluctuation is absorbed by the movement of the tension roller 2 caused by the action of tension roller rotation shaft support means 31.

Assume that, of the belt feed paths, the path leading from the drive roller 1 to the tension roller 2 is defined as a drive roller downstream path 11, and the path leading from the tension roller 2 to the drive roller 1 as a drive roller upward path 12. Then the fluctuation of the position caused by the eccentricity of the idle roller 3a located on the drive roller downstream path 11 is not transmitted to the drive roller upstream path 12. The fluctuation of the position caused by the eccentricity of the idle roller 3b located on the drive roller upstream path 12 is not transmitted to the drive roller downstream path 11.

In other words, when the belt path is divided into the drive roller upstream path 12 and drive roller downstream path 11, the fluctuation of the speed caused by the idle roller 3b located on one path is not transmitted to the other path.

Accordingly, image misregistration is affected even if eccentricity is found in the idle roller located on either the drive roller upstream path 12 or drive roller downstream path 11 where a latent image is formed. However, image misregistration is not affected by the eccentricity of the roller located on the path where a latent image is not formed.

The present invention is based on the above argument to make a selective arrangement of the roller with smaller eccentricity, thereby maintaining the required image quality and reducing the production cost.

In the embodiment shown in FIG. 1, the amount of eccentricity of the idle roller 3a located on the above stated drive roller downstream path is made smaller than that of the idle roller 3b located on the drive roller upstream path. The latent image processing apparatus is arranged on the drive roller downstream path. Thus, image misregistration is not affected by the idle roller 3b located on upstream path as described above.

This arrangement reduces the misregistration of the image misregistration resulting from the eccentricity of idle rollers, with the result that there is no need for high-precision machining of the idle roller 3b, and production costs are reduced by the corresponding amount.

FIG. 4 is a drawing representing another embodiment of the image forming apparatus related to the first embodiment according to the present invention.

In FIG. 4, the amount of eccentricity of the idle roller 3b located on the a drive roller upstream path is made smaller than that of the idle roller 3a located on the drive roller downstream path, and the above stated latent image processing apparatus is arranged on the above stated drive roller downstream path.

Although not illustrated in FIG. 3, the latent image forming apparatus 6 is located on the upstream side of the drive roller. This ensures that image misregistration is not affected by the idle roller 3a located on the drive roller downstream path. Thus, the image misregistration resulting from idle roller eccentricity can be reduced, with the result that there is no need for high-precision machining of the idle roller 3a, and production costs are reduced by the corresponding amount.

In the above stated two embodiments, the idle roller arranged on either the drive roller upstream path or drive roller downstream path where the latent forming position is included to ensure that the formed image does not exceed the permissible maximum misregistration “d”, the idle roller 3a and 3b are configured in such a way that eccentricity “e” meets the requirements of e<d(θ/π)

where the permissible maximum misregistration is “d”, the radius of the idle roller 3b located on the drive roller upstream path “r”, and winding angle “θ”.

Furthermore, rational cost reduction is ensured by setting the idle roller arranged on the path including the position of the latent image forming apparatus 6 in such a way that the eccentricity of the idle roller having a greater belt winding angle is smaller than that of the idle roller having a smaller belt winding angle.

Generally, stable belt feed requires tension to be given to the belt. Belt extension and contraction result when tension is applied to the belt, but the image quality can be maintained if the extension of the belt δλ resulting from the fluctuation of tension δT subsequent to application of the tension required for stable feed is kept below the permissible maximum image misregistration “d”. Assuming that the belt peripheral length is “1”, width “w”, thickness “t” and Young's modulus “E”, then tension fluctuation δT is expressed as δT=(wtE δλ)/1.

In this case, force “dF” acting on the elastic member provided on the tension roller shaft supporting member is given as δF=kδx

where the spring constant of the elastic member is “k” and the displacement thereof is “δx”.

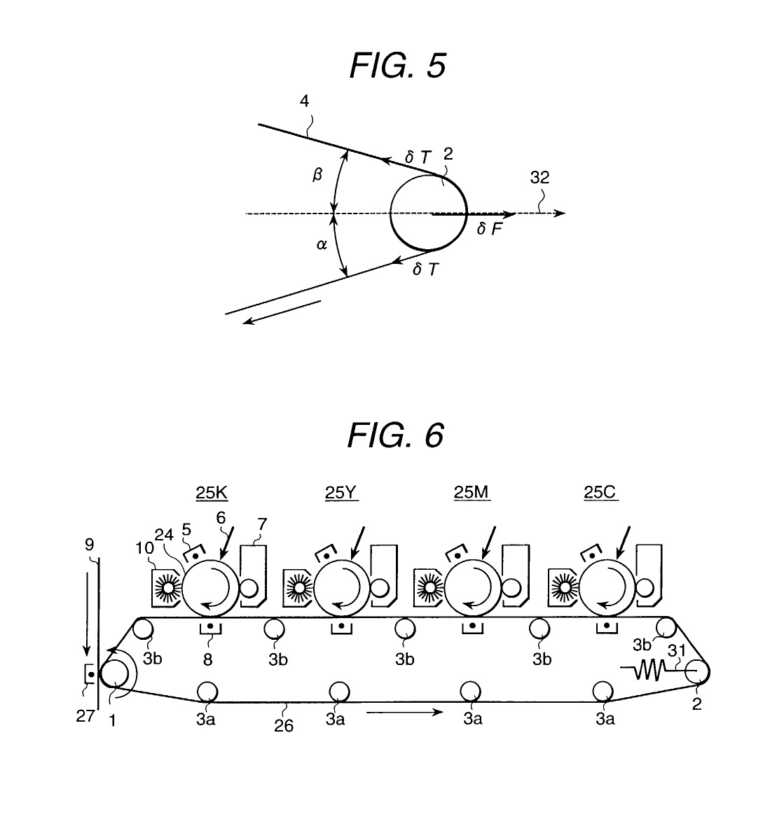

When the tension roller travels in the direction shown by 32 in FIG. 5, and angles formed between the traveling direction, and drive roller upstream path and drive roller downstream path are α and β, respectively, then the above stated T and F are related with each other as follows:

δF=(cos α+cos β)δT

Here the image misregistration can be kept below the permissible value “d” when δλ<d. If consideration is given to the fact that the displacement δx of the elastic member is equivalent to the total of all the roller eccentricities Σe at most, then the above stated relationship can be met when the spring constant k of the elastic member meets the following:

k<wtE(cos α+cos β)d/(1Σe)

In this case, image misregistration can be kept below the permissible value.

FIG. 6 is a drawing representing an image forming apparatus as a further embodiment of the present invention.

In FIG. 6, this apparatus comprises monochromatic image forming means 25K, 25Y, 25M and 25C for forming monochromatic toner images of black, yellow, magenta and cyan respectively, and belt shaped intermediate transfer member 26 applied to the drive roller 1, tension roller 2 and idle rollers 3a and 3b. Each of the image forming means 25K, 25Y, 25M and 25C comprises an electric charging apparatus 5, a latent image forming apparatus 6 consisting of laser and light emitting diode, a development apparatus 7,a transfer apparatus 8 and a cleaner 10 arranged around the drum shaped image carrier 24.

In the image forming apparatus, the monochromatic toner images formed by image forming means 25K, 25Y, 25M and 25C are transferred onto the belt shaped intermediate transfer member 26 by the transfer apparatus 8, and are overlaid one on top of another, thereby forming a color image. The formed color image is transferred onto the recording medium 9 such as recording paper by a transfer apparatus 27, and is fixed on the recording medium 9 by a fixing apparatus (not illustrated) in the final stage.

In this image forming apparatus, the image position is determined at the transfer point where an image is transferred from the monochromatic image forming means to the intermediate transfer member.

As described above, in the image forming apparatus shown in FIG. 6, the transfer point is located on the drive roller upstream path. Accordingly, the image misregistration resulting from idle roller eccentricity can be reduced if the amount of eccentricity of the idle roller 3b located on the drive roller upstream path is made smaller than that of the idle roller 3a located on the drive roller downstream path. This arrangement will reduce the cost that would be required by high precision machining of the idle roller 3a.

Conversely, when the transfer point is located on the driver roller downstream path, the image misregistration resulting from idle roller eccentricity can be reduced if the amount of eccentricity of the idle roller 3a located on the drive roller downstream path is made smaller than that of the idle roller 3b located on the drive roller upstream path. This arrangement will reduce the cost that would be required by high precision machining of the idle roller 3b.

In this embodiment as well, it is possible to ensure that the formed image does not exceed the permissible maximum image misregistration “d”, if the idle roller 3a or 3b arranged on either the drive roller upward path or downward path where the transfer point is included is configured in such a way that “e” satisfies the relationship of e<d(θ/π)

where the maximum permissible misregistration is “d”, the radius of the idle roller located on the drive roller upstream path “r”, the winding angle “θ” and eccentricity “d”.

Furthermore, rational cost reduction is ensured by setting the idle roller arranged on the path including the transfer point in such a way that the eccentricity of the idle roller having a greater belt winding angle is smaller than that of the idle roller having a smaller belt winding angle.

FIG. 6 shows an example of the so-called tandem type colored image forming apparatus comprising multiple monochromatic image forming means equipped with drum shaped image carriers. The present invention, however, is not restricted thereto. A belt shaped image carrier may be used, or a monochromatic image forming apparatus equipped with single monochromatic image forming means may be utilized.

Furthermore, FIG. 6 shows the configuration with an intermediate transfer member. A configuration with a paper fed belt instead of the intermediate transfer member is also possible.

The present invention provides an image forming apparatus further characterized in that image misregistration resulting from idle roller eccentricity is reduced and high precision machining of all multiple idle rollers is not necessary, whereby excellent image quality and reduced machining cost are ensured.

What is claimed is:

1. An image forming apparatus comprising:
a latent image forming apparatus having a belt shaped carrier applied on a drive roller, multiple idlers and a tension roller, said latent image forming apparatus mounted on said belt shaped carrier,
a developing apparatus for applying toner on the latent image formed by said latent image forming apparatus, and
a transfer apparatus for transferring the toner image formed by said developing apparatus,
said image forming apparatus, wherein
when a path leading from said drive roller to said tension roller in the forward direction of said belt shaped carrier is defined as a drive roller downstream path, and
when a path leading from said tension roller to said drive roller is defined as a drive roller upstream path,
the amount of eccentricity of the idle roller located on said drive roller downstream path is made smaller than that of the idle roller located on said drive roller upstream path, and
said latent image forming apparatus is arranged on said drive roller downstream path.

2. An image forming apparatus comprising:
a latent image forming apparatus having a belt shaped carrier applied on a drive roller, multiple idlers and a tension roller, said latent image forming apparatus mounted on said belt shaped carrier,
a developing apparatus for applying toner on the latent image formed by said latent image forming apparatus, and
a transfer apparatus for transferring the toner image formed by said developing apparatus,
said image forming apparatus, wherein
when a path leading from said drive roller to said tension roller in the forward direction of said belt shaped carrier is defined as a drive roller downstream path, and
when a path leading from said tension roller to said drive roller is defined as a drive roller upstream path,
the amount of eccentricity of the idle roller located on said drive roller upstream path is made smaller than that of the idle roller located on said drive roller downstream path, and
said latent image forming apparatus is arranged on said drive roller upstream path.

3. An image forming apparatus according to claim 1, wherein
when the radius of said idle roller is “r”, eccentricity “e”, winding angle θ[rad] and the maximum permissible misregistration “d”,
the eccentricity “e” of the idle roller arranged on the path including the position of said latent image forming apparatus is expressed as e<d(θ/π).

4. An image forming apparatus according to any one of claims 1 to 3, wherein
the eccentricity of the idle roller having a greater winding angle of said belt shaped carrier is smaller than that of the idle roller having a smaller winding angle.

5. An image forming apparatus comprising:
multiple monochromatic image forming means having a belt shaped intermediate transfer member applied on a drive roller, multiple idlers and a tension roller, said monochromatic image forming means mounted on said belt shaped intermediate transfer member,
a transfer apparatus for transferring on said belt shaped intermediate transfer member the monochromatic toner image formed by said monochromatic image forming means, and
a transfer apparatus for transferring on a recording medium the colored image obtained by overlaying said monochromatic toner images,
said image forming apparatus, wherein
when a path leading from said drive roller to said tension roller in the forward direction of said belt shaped carrier is defined as a drive roller downstream path, and
when a path leading from said tension roller to said drive roller is defined as a drive roller upstream path,the amount of eccentricity of the idle roller located on said drive roller downstream path is made smaller than that of the idle roller located on said drive roller upstream path,
said latent image forming apparatus is arranged on said drive roller downstream path.

6. An image forming apparatus comprising:
multiple monochromatic image forming means having a belt shaped intermediate transfer member applied on a drive roller, multiple idlers and a tension roller, said monochromatic image forming means mounted on said belt shaped intermediate transfer member,
a transfer apparatus for transferring on said belt shaped intermediate transfer member the monochromatic toner image formed by said monochromatic image forming means, and
a transfer apparatus for transferring on a recording medium the colored image obtained by overlaying said monochromatic toner images,
said image forming apparatus, wherein
when a path leading from said drive roller to said tension roller in the forward direction of said belt shaped carrier is defined as a drive roller downstream path, and
when a path leading from said tension roller to said drive roller is defined as a drive roller upstream path,
the amount of eccentricity of the idle roller located on said drive roller upstream path is made smaller than that of the idle roller located on said drive roller downstream path, and
said latent image forming apparatus is arranged on said drive roller upstream path.

7. An image forming apparatus according to claim 5 characterized in that,
when the radius of said idle roller is “r”, eccentricity “e”, winding angle θ[rad] and the maximum permissible misregistration “d”,
the eccentricity “e” of the idle roller arranged on the path including the position of the transfer point is expressed as e<d(θ/π).

8. An image forming apparatus according to any one of claim 5 and 6, wherein
the eccentricity of the idle roller having a greater winding angle of said belt shaped intermediate transfer member is smaller than that of the idle roller having a smaller winding angle.

9. An image forming apparatus according to any one of claims 1 to 7, wherein
said image forming apparatus comprises a support member for supporting said tension roller rotating shaft in linearly movable manner in parallel, and said support member comprises an elastic member;
said image forming apparatus further characterized in that;
when the peripheral length of said belt shaped carrier or intermediate transfer member is “1”, width “w”, thickness “t”, Young's modulus “E”, the total of the eccentricities of all rollers to which said belt shaped carrier or intermediate transfer member is applied “Σe”, the maximum permissible image position misregistration “d” and angles formed by said tension roller traveling direction and the upstream and downstream path of said belt shaped carrier or intermediate transfer member α and β;
then the spring constant k of said elastic member can be expressed as k<wtE(cos α+cos β)d/(1Σe).
